(19) United States
(12) Patent Application Publication
(10) Pub. No.: US 2005/0213332 A1
(43) Pub. Date: Sep. 29, 2005

(54) Par lamp

(75) Inventors: George Kendrick, Lexington, KY (US); Michael R. Kling, Lexington, KY (US)

Correspondence Address: OSRAM SYLVANIA INC, 100 ENDICOTT STREET, DANVERS, MA, 01923, US

(73) Assignee: OSRAM SYLVANIA, INC., Danvers, MA (US)

(21) Appl. No.: 11/157,681

(22) Filed: Jun. 21, 2005

(51) Int. Cl. F21V 29/00

(52) U.S. Cl. 362/296

(57) ABSTRACT

An electric lamp may be formed from a lamp capsule including an electric light source enclosed in an envelope. A skirt mechanically couples to the base, and extends from the base to a lip edge offset axially from the threaded exterior wall. The lamp includes a reflector having an interior side with a reflective portion, an exterior side, the reflector being formed with an interior wall defining a through passage extending between the interior side and the exterior side. The lamp capsule is extended through the through passage to locate the light source opposite the reflective portion. The skirt defines an isolated cavity retaining the seal end of the lamp capsule, and may further include an insulation plate intermediate the lamp and any circuitry.

### BACKGROUND OF THE INVENTION

1. Field of the Invention

The invention relates to electric lamps and particularly to electric lamps. More particularly the invention is concerned with line voltage electric lamps enclosed in a reflector.

2.

### Description of the Related Art Including Information Disclosed Under 37 CFR 1.97 AND 1.98

FIG. 1 shows a cross sectional view of a prior art PAR lamp. PAR lamps are commonly formed from a reflector shell with an extended neck that is coupled to a threaded base. Eyelets held in narrow passages provide electrical connection and mechanical support for the lamp capsule. This structure at once traps heat and light in the neck of the reflector, heating the seal region, and also diminishes the amount of light accurately spotted in the in the beam by what is lost in the neck cavity. It also constricts the volume in the base available for other functions. There is then a need for a PAR lamp neck structures that better controls heat and light flow and opens the volume for other functions.

### BRIEF SUMMARY OF THE INVENTION

An electric lamp may be formed from a lamp capsule including an electric light source enclosed in an envelope. A first electric lead and a second electric lead extend in a sealed fashion through a seal region of the envelope. The lamp includes a base having a threaded exterior wall including a first electrical contact, an axially located second contact and an electrical insulator retaining the first contact and the second contact in fixed relative electrical isolation. The first electric lead is electrically coupled to the first contact and the second electric lead is electrically coupled to the second contact. A skirt mechanically couples to the base, and extends from the base to a lip edge offset axially from the threaded exterior wall. The lamp includes a reflector having an interior side with a reflective portion, an exterior side, the reflector being formed with an interior wall defining a through passage extending between the interior side and the exterior side. The lamp capsule is extended through the through passage to locate the light source opposite the reflective portion. The lamp capsule envelope and interior wall being in close mechanical association, and the lip edge being mechanically coupled to the exterior side.

### BRIEF DESCRIPTION OF THE SEVERAL VIEWS OF THE DRAWINGS

FIG. 1 shows a cross sectional view of a prior art PAR lamp.

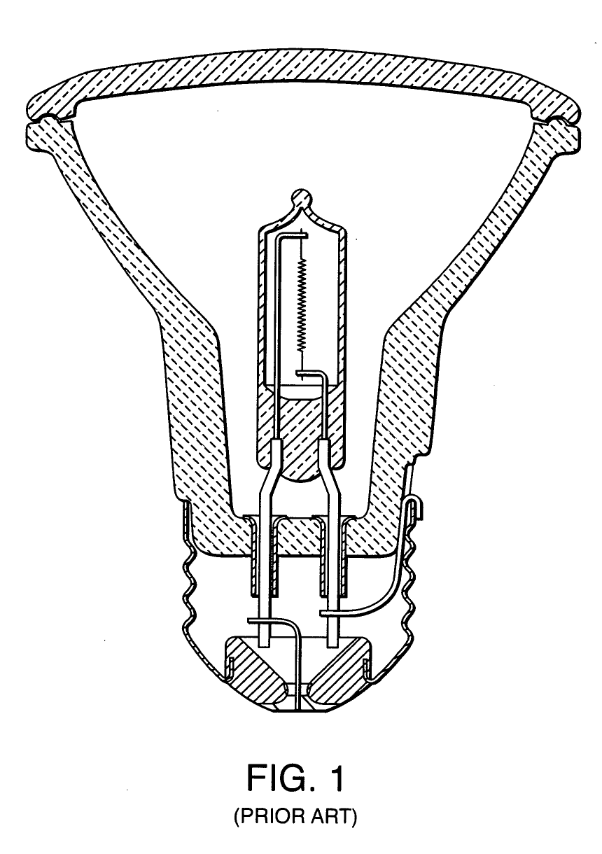

FIG. 2 shows a cross sectional view of a preferred PAR lamp.

FIG. 3 shows a cross sectional view of an alternatively preferred PAR lamp with a voltage controlling circuit.

### DETAILED DESCRIPTION OF THE INVENTION

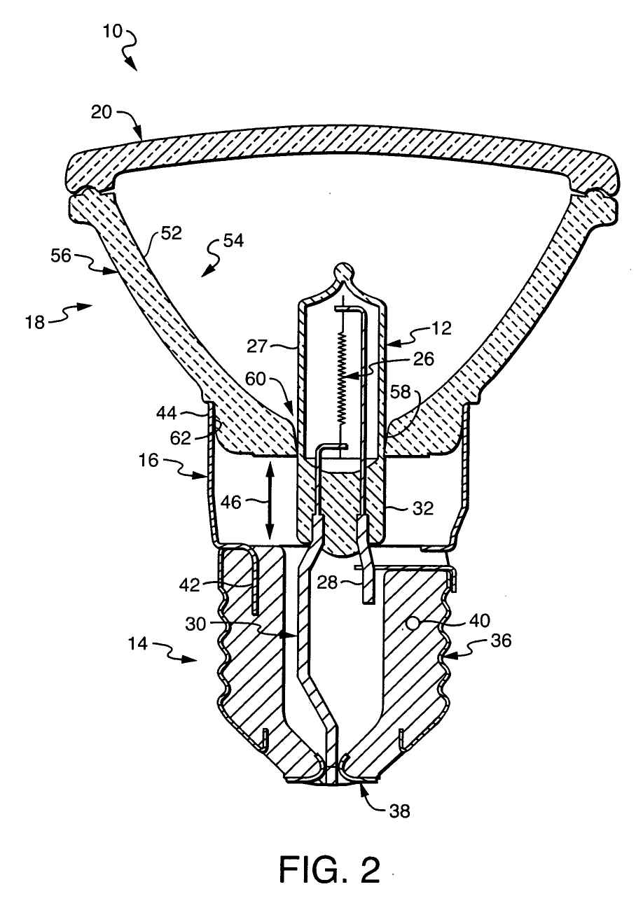

FIG. 2 shows a cross sectional view of a preferred PAR lamp. The preferred electric lamp 10 is formed from a lamp capsule 12, a base 14, a skirt 16, a reflector 18, a lens 20, a circuit 22 and a thermal insulation plate 24.

The lamp capsule 12 may be a tubular tungsten halogen incandescent capsule 12 with includes an electric light source, such as a coiled coil light source 26 enclosed in a quartz or hardglass envelope 27. A first electric lead 28 and a second electric lead 30 extend in a sealed fashion through a press seal region 32 of the envelope 27.

The base 14 may be formed as a brass or other metal shell 34 with a threaded exterior wall including a first electrical contact 36, such as some or all of the threaded portion. The base 14 also has an axially located second electrical contact 38, such as the center contact typical of Edison type lamps. An electrical insulator 40, such as a glass gob, retains the first contact 36 and the second contact 38 in fixed relative electrical isolation. The first electric lead 28 is electrically coupled to the first contact 36, either directly as a welded contact or indirectly through a connection wire, which may include a fuse portion. The second electric lead 30 is electrically coupled to the second contact 38; for example by soldering or welding the second electric lead 30 to a centrally retained eyelet, and trimming any excess lead, soldier or weld material as the case may be.

The skirt 16 may be a brass tube with a funnel like flaring to accommodate the differing diameters of the base 14 and the reflector 18. The skirt 16 has a first edge 42 mechanically coupled to the base 14, for example a ring like edge captured in the material of the electrical insulator 40. Where the electric insulator 40 is a glass gob, an edge of the skirt 16 may be captured in the molten glass. Where the electric insulator 40 is a molded ceramic, the skirt 16 may be peened, epoxied or similarly mechanically coupled the molded ceramic. The skirt 16 further includes a portion extending away from the first edge 42, a section with a lip edge 44 offset 46 axially from the threaded base l4. The axial offset 46 may be selected so as to properly space the base 14 axially from the reflector 18 and thereby adapt the lamp length to existing or differing PAR lamp fixtures. The lip edge 44 may have a sufficiently large inside diameter to overlap closely and thereby facilitate mechanical coupling with an outside diameter of the base 14 end of the reflector 18.

The reflector 18 may be a pressed glass, bowl shaped body. The reflector 18 has an interior side 52 with a reflective surface 54, and an exterior side 56. The reflector 18 is also formed with an interior wall 58 defining a through passage 60 extending between the interior side 52 and the exterior side 56. The through passage 60 is large enough to admit the insertion of the lamp capsule 12 from the exterior side to enable at least the exposure of the light source 26 to the reflective surface 54. In the preferred embodiment, the reflector 18 includes an optical focal point for the reflective surface 54. The lamp capsule 12 is extended through the through passage 60 to locate the light source 26 opposite the reflective surface 54, so light from the light source 26 is reflected by the reflective surface 54 forward to a region to be illuminated. The lamp capsule 12 envelope 27 and interior wall 58 are in close mechanical association so the capsule 12 does not sway from side to side and is generally properly located with respect to the reflector 18 by the closely limited positioning required to fit in the through passage 60. The close association of the lamp capsule 12 and the reflector 18 limits light and heat from passing there between and thereby heating the base region. In the preferred embodiment, the seal region of the lamp capsule 12 is positioned intermediate the exterior side 56 and the base 14 in a cavity enclosed by the skirt 16. The exterior side 56, base 14 end of the reflector 18 may be formed with an approximately cylindrical shoulder 62, which may include recesses or protrusions that are distributed around the shoulder 62. The lip edge 44 of the skirt 16 is mechanically coupled to the exterior side 56 of the reflector 18, for example along a formed shoulder 62, to retain the base 14 and reflector 18 in a fixed relation. The mechanical coupling may be made by peening the lip edge 44 to recesses or protrusions formed on the outside of the reflector 18 or by gluing the two pieces together with an appropriate material, such as an epoxy.

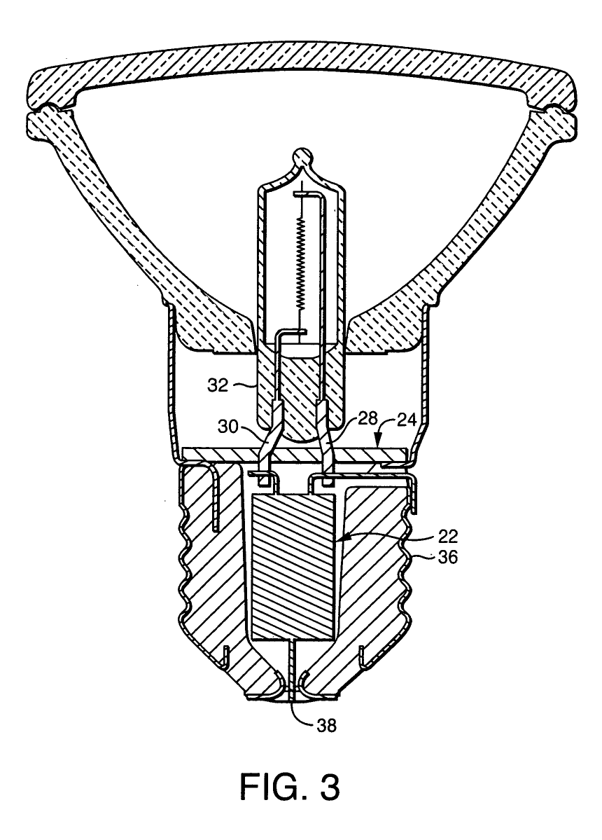

FIG. 3 shows a cross sectional view of an alternatively preferred PAR lamp with a voltage controlling circuit. The lamp may include a voltage reduction circuit 22 that may be electrically coupled intermediate the first electric lead 28 and between the first contact 36 and the second electric lead 30 and the second contact 38. The circuit 22 may be retained in a cavity defined within the electric insulator 40 and the threaded base 14.

Preferably positioned intermediate the lamp capsule 12 and the circuit 22 is a thermal insulation plate 24. Plate 24 is preferably electrically insulating, and optically opaque material. The thermal insulation plate 24 may have one or more passages to enable the electrical connection of the light source 26 to the circuit 22 or the first contact 36 or second contact 38 as the case may be. The thermal insulation plate 24 may encircle a portion of the lamp capsule 12, the press seal 32, or the leads 28, 32. The plate 24 is electrically insulating to avoid shorting between the first electric lead 28 and the second electric lead 30, and is opaque to prevent light, and in particularly infrared radiation from shining on and heating the circuit 22 board or the nearby base 14 elements. Preferably the skirt 16 is vented with one or more holes 64 allowing air and therefore heat to pass from the enclosed volume to the exterior.

The cover lens 20 may be a pressed glass disk formed appropriately with lensing elements as is known in the art. A circumferential edge of the lens 20 is then sealed to a corresponding edge formed on the axial end of the reflector 18. The reflector 18 and lens 20 may be flame sealed or glued, for example with a silicon seal or an epoxy to bond the reflector 18 and the lens 20. The reflector 18 and the lens 20 once coupled together define a cavity that substantially encloses the light source 26.

While there have been shown and described what are at present considered to be the preferred embodiments of the invention, it will be apparent to those skilled in the art that various changes and modifications can be made herein without departing from the scope of the invention defined by the appended claims.

1. An electric lamp comprising:
a lamp capsule including an electric light source enclosed in an envelope, a first electric lead and a second electric lead extending in a sealed fashion through a seal region of the envelope;
a base having an threaded exterior wall including a first electrical contact, an axially located second contact and an electrical insulator retaining the first contact and the second contact in fixed relative electrical isolation, the first electric lead being electrically coupled to the first contact and the second electric lead being electrically coupled to the second contact;
a skirt mechanically coupled to the base, an extending from the base with a lip edge offset axially from the threaded exterior wall; and
a reflector having an interior side with a reflective portion, an exterior side, the reflector being formed with an interior wall defining a through passage extending between the interior side and the exterior side; the lamp capsule be extended through the through passage to locate the light source in opposite the reflective portion, the lamp capsule envelope and interior wall being in close mechanical association; and the lip edge being mechanically coupled to the exterior side.

2. The lamp in claim 1, wherein electrical insulator mechanically traps an edge of the skirt.

3. The lamp in claim 1, where in the seal region is positioned intermediate the outer side and the base in a cavity enclosed by the skirt.

4. The lamp in claim 1, further including a voltage reduction circuit electrically coupled intermediate the first electric lead and the first contact and the second electric lead and the second contact.

5. The lamp in claim 4, wherein the circuit is retained in a cavity defined in the electric insulator and the threaded base.

6. The lamp in claim 5, further including a thermal insulation plate positioned intermediate the electric circuit and the seal region.

7. The lamp in claim 1, further including a cover lens coupled to the reflector to define a cavity substantially enclosing the light source.

8. An electric lamp comprising:
a lamp capsule including an electric light source enclosed in an envelope, a first electric lead and a second electric lead extending in a sealed fashion through a seal region of the envelope;
a base having an threaded exterior wall including a first electrical contact, an axially located second contact and an electrical insulator retaining the first contact and the second contact in fixed relative electrical isolation, the first electric lead being electrically coupled to the first contact and the second electric lead being electrically coupled to the second contact;
a skirt having a first edge mechanically coupled to the base, an extending from the base with a lip edge offset axially from the threaded exterior wall;
a reflector having an interior side with a reflective portion, an exterior side and formed with an interior wall defining a through passage extending between the interior side and the exterior side; the lamp capsule be extended through the through passage to locate the light source in opposite the reflective portion, the lamp capsule envelope and interior wall being in close mechanical association; the seal region being positioned intermediate the outer side and the base in a cavity enclosed by the skirt; the lip edge of the skirt being mechanically coupled to the exterior side to retain the base and reflector in a fixed relation;
a voltage reduction circuit electrically coupled intermediate the first electric lead and the first contact and the second electric lead and the second contact; the circuit being retained in a cavity defined in the electric insulator and the threaded base;
a thermal insulation plate positioned intermediate the electric circuit and the seal region, the thermal insulation plate having at least viaspassages enabling electrical connection between the light source and the circuit; and
a cover lens coupled to the reflector to define a cavity substantially enclosing the light source.
